(19) United States
(12) Patent Application Publication
(10) Pub. No.: US 2025/0153545 A1
(43) Pub. Date: May 15, 2025

(54) VAPOR INJECTION MODULE AND VEHICLE HEAT MANAGEMENT DEVICE INCLUDING SAME

(71) Applicant: Hanon Systems, Daejeon (KR)

(72) Inventors: Seong Hun KIM, Daejeon (KR); Yun Jin KIM, Daejeon (KR); Sung Je LEE, Daejeon (KR); Hae Jun LEE, Daejeon (KR)

(21) Appl. No.: 18/840,575

(22) PCT Filed: Apr. 21, 2023
(86) PCT No.: PCT/KR2023/005455

§ 371 Date: Aug. 22, 2024

(30) Foreign Application Priority Data
May 20, 2022 (KR) 10-2022-0062092

(51) Int. Cl. B60H 1/32

(52) U.S. Cl. CPC B60H 1/3228

(57) ABSTRACT

A vehicle heat management device comprising a compressor compressing and circulating a refrigerant; a first heat exchanger into which the compressed refrigerant flows and exchanges heat with another heat exchange medium; a second heat exchanger exchanging heat with air outside a vehicle interior; a third heat exchanger that is installed in an air conditioner and exchanges heat with air discharged into the vehicle interior; and a vapor injection module that can make a gaseous refrigerant flow into the compressor. The vapor injection module includes a plurality of expansion means and a gas-liquid separator. In a cooling mode, refrigerant that has passed through the second heat exchanger flows into the vapor injection module. In a heating mode, refrigerant that has passed through the first heat exchanger flows into the vapor injection module. Accordingly, the vehicle heat management device can be compact while having improved cooling and heating performance.

### TECHNICAL FIELD

Embodiments relate to a vapor injection module and a vehicle heat management device including the same. Specifically, the embodiments relate to a vehicle heat management device, which can be compact and can improve cooling and heating performance and quality using a vapor injection module including a plurality of expansion means and one gas-liquid separator.

### BACKGROUND ART

Vehicles are provided with an air conditioner for controlling interior air temperature. The air conditioner keeps a vehicle interior warm by generating warm air or keeps the vehicle interior cool by generating cold air. Here, a vehicle air conditioner may include a compressor, a condenser, an expansion valve, an evaporator, pipes connecting them, etc. to circulate refrigerant that is a heat exchange medium.

Most of the vehicles provided with such an air conditioner use an internal combustion engine driven using fossil fuels such as gasoline and diesel as an energy source. Therefore, there is a need for new energy sources due to various causes such as environmental pollution problems and decrease in oil reserves. Therefore, eco-friendly vehicles such as electric vehicles and fuel cell vehicles are emerging.

In the case of a vehicle using the internal combustion engine (hereinafter referred to as an “internal combustion engine vehicle”), a vehicle interior may be heated using cooling water cooling the internal combustion engine. For example, the internal combustion engine vehicle may be provided with a heating system using cooling water to heat the vehicle interior using heat absorbed from the internal combustion engine to heat the vehicle interior.

However, since vehicles using fuel cells, etc. do not use an internal combustion engine, there is a problem that a heating system that uses the internal combustion engine of the vehicle as a heat source cannot be used.

Therefore, the vehicles using fuel cells, etc. add a heat pump to an air conditioner and use the heat pump as a heat source, or are provided with a separate heat source such as an electric heater to heat a vehicle interior. Here, the heat pump may be a device for absorbing low-temperature heat and then transferring the absorbed heat to a high temperature. As an example, a heat pump has a cycle in which liquid refrigerant evaporates in an evaporator, takes heat from the surroundings to become a gas, and then liquefies while re-discharging heat to the surroundings by a condenser. When the heat pump is applied to electric vehicles or hybrid electric vehicles, there is an advantage in that it is possible to secure a heat source that is lack in conventional general air conditioners.

In a heat pump system in which such a heat pump is disposed, a vapor injection system may be used to improve cooling and heating performance. Here, the vapor injection system has a structure in which a refrigerant circulation system for cooling and heating allows gaseous refrigerant to re-flow into a compressor using a gas-liquid separator and supplies liquid refrigerant to an evaporator or a chiller.

Since conventional heat pump systems should be provided with at least two gas-liquid separators for each cooling and heating, there are limitations in providing a compact heat pump system. Therefore, such a size limit affects the arrangement relationship with nearby components and thus acts as a limiting factor in a degree of freedom in design of the heat pump system.

In addition, the conventional heat pump systems include at least two gas-liquid separators for each cooling and heating. To control refrigerant discharged from each gas-liquid separator according to an air conditioning mode, a check valve should be used at a gaseous outlet side of the gas-liquid separator.

Such a check valve may act as a factor that reduces the performance of the conventional heat pump systems.

In addition, since the conventional heat pump systems require additional components such as the check valve, there is a problem of low productivity.

Therefore, there is a demand for a vehicle heat management device that may implement a compact size while removing the check valve disposed at the gaseous outlet side of the gas-liquid separator.

### DISCLOSURE

### Technical Problem

Embodiments are directed to providing a vehicle heat management device which uses only one gas-liquid separator and from which a check valve disposed at a gaseous outlet side of the gas-liquid separator has been removed.

Embodiments are also directed to providing a compact vehicle heat management device through a modularized vapor injection module.

Embodiments are also directed to providing a vehicle heat management device for providing an optimized arrangement structure for each component of a vapor injection module.

Objectives to be solved by embodiments are not limited to the objectives described above, and objectives which are not described above will be clearly understood by those skilled in the art from the following descriptions.

### Technical Solution

To achieve the objects, there is provided a vehicle heat management device including a compressor configured to compress and circulate refrigerant, a first heat exchanger into which the compressed refrigerant is introduced to exchange heat with another heat exchanger medium, a second heat exchanger configured to exchange heat with air outside a vehicle interior, a third heat exchanger mounted on an air conditioner to exchange heat with air discharged to the vehicle interior; and a vapor injection module capable of allowing gaseous refrigerant to flow into the compressor, wherein the vapor injection module includes a plurality of expansion means and one gas-liquid separator, in a cooling mode, refrigerant passing through the second heat exchanger flows into the vapor injection module, and in a heating mode, refrigerant passing through the first heat exchanger flows into the vapor injection module.

Preferably, the vapor injection module may include a first expansion means group for heating and a second expansion means group for cooling, an outlet of the first heat exchanger may be connected to the first expansion means group, and an outlet of the second heat exchanger may be connected to the second expansion means group.

Preferably, in a cooling mode of the vehicle heat management device, the refrigerant passing through the first heat exchanger may flow into the gas-liquid separator through the first expansion means, the second heat exchanger, and the fourth expansion means, gaseous refrigerant separated in the gas-liquid separator may move to the compressor, and liquid refrigerant separated in the gas-liquid separator may be expanded by the third expansion means and then may move to the third heat exchanger.

Preferably, when the refrigerant passing through the first heat exchanger moves along the first expansion means, the second heat exchanger, the fourth expansion means, and the gas-liquid separator, the refrigerant may be expanded by only the fourth expansion means.

Preferably, in a heating mode of the vehicle heat management device, the refrigerant passing through the first heat exchanger may be expanded by the second expansion means and then may flow into the gas-liquid separator, gaseous refrigerant separated in the gas-liquid separator may move to the compressor, and liquid refrigerant separated in the gas-liquid separator may be expanded by the first expansion means, may pass through the second heat exchanger, and then move to the compressor.

Preferably, in a dehumidification mode of the vehicle heat management device, the refrigerant passing through the first heat exchanger may be expanded by the second expansion means and then may flow into the gas-liquid separator, gaseous refrigerant separated in the gas-liquid separator may move to the compressor, liquid refrigerant separated in the gas-liquid separator may be branched to each of the first expansion means and the third expansion means, the refrigerant flowing into and expanded by the first expansion means may pass through the second heat exchanger and then flow into the compressor, and the refrigerant flowing into and expanded by the third expansion means may pass through the third heat exchanger and then flow into the compressor.

To achieve the objects, there is provided a vehicle heat management device including a first line connecting a compressor, an interior heat exchanger, a vapor injection module, an evaporator, and an accumulator, a second line connecting the vapor injection module to an exterior heat exchanger, a third line connecting the vapor injection module to the compressor, and a fourth line having one side connected to the first line between the evaporator and the accumulator and the other side connected to the second line between the exterior heat exchanger and the vapor injection module, wherein the vapor injection module includes a first expansion means and a second expansion means that are connected to the first line at an outlet side of the interior heat exchanger, a third expansion means and a fourth expansion means that are connected to the second line at an outlet side of the exterior heat exchanger, and one gas-liquid separator, the first expansion means and the third expansion means are connected in parallel to a liquid outlet of the gas-liquid separator, the second expansion means and the fourth expansion means are connected in parallel to an inlet of the gas-liquid separator, and a gaseous outlet of the gas-liquid separator is connected to the compressor.

Preferably, each of the first expansion means and the third expansion means may be a three-way expansion valve including two inlets and one outlet, and the outlet of the first expansion means may be connected to an inlet side of the exterior heat exchanger, and an outlet of the third expansion means may be connected to the evaporator.

Preferably, by the second expansion means and the fourth expansion means, only one of a heat exchange medium passing through the second expansion means or a heat exchange medium passing through the fourth expansion means may be supplied to the gas-liquid separator.

To achieve the objects, there is provided a vehicle heat management device including a compressor configured to compress and circulate refrigerant, a first heat exchanger into which the compressed refrigerant is introduced to exchange heat with another heat exchanger medium, a second heat exchanger configured to exchange heat with air outside a vehicle interior, a third heat exchanger mounted on an air conditioner to exchange heat with air discharged to the vehicle interior, and a vapor injection module capable of allowing gaseous refrigerant to flow into the compressor, wherein the vapor injection module includes a first expansion means group, a second expansion means group, one gas-liquid separator, a first joining part disposed at an inlet of the gas-liquid separator and connected to the first expansion means group and the second expansion means group, and a first branch part disposed at a liquid outlet of the gas-liquid separator and connected to the first expansion means group and the second expansion means group.

Preferably, the vehicle heat management device may include a first line connecting the compressor, the first heat exchanger, the vapor injection module, the third heat exchanger, and an accumulator, a second line connecting the vapor injection module to the second heat exchanger, a third line connecting the vapor injection module to the compressor, a fourth line having one side connected to the first line between the third heat exchanger and the accumulator and the other side connected to the second line between the second heat exchanger and the vapor injection module, and a chiller and a fifth expansion means that are disposed on the fourth line.

Preferably, the first expansion means group may include a 3-way valve type first expansion means including two inlets and one outlet, a 2-way valve type second expansion means, and a second branch part disposed at an outlet of the first heat exchanger and connected to the first expansion means and the second expansion means, the second expansion means group may include a 3-way valve type third expansion means including two inlets and one outlet, a 2-way valve type fourth expansion means, and a third branch part disposed at an outlet of the second heat exchanger and connected to the third expansion means and the fourth expansion means, an outlet of the first expansion means may be connected to the second line at an inlet side of the second heat exchanger, one of inlets of the first expansion means may be connected to the first branch part, an outlet of the second expansion means may be connected to the first joining part, an outlet of the third expansion means may be connected to the first line at an inlet side of the third heat exchanger, one of inlets of the third expansion means may be connected to the first branch part, and an outlet of the fourth expansion means may be connected to the first joining part.

To achieve the objects, there is provided a vehicle heat management device including a first line connecting a compressor, an interior heat exchanger, a vapor injection module, an evaporator, and an accumulator, a second line connecting the vapor injection module to an exterior heat exchanger, a third line connecting the vapor injection module to the compressor, and a fourth line having one side connected to the first line between the evaporator and the accumulator and the other side connected to the second line between the exterior heat exchanger and the vapor injection module, wherein the vapor injection module includes a first expansion means group connected to the first line at an outlet side of the interior heat exchanger based on a flow of a heat exchange medium, a second expansion means group connected to the second line at an outlet side of the exterior heat exchanger based on the flow of the heat exchange medium, one gas-liquid separator, the first flow path connecting the first expansion means group, the second expansion means group, and the gas-liquid separator through a first joining part, and the second flow path connecting the gas-liquid separator, the first expansion means group, and the second expansion means group through a first branch part disposed at a liquid outlet side of the gas-liquid separator, the third line is connected to a gaseous outlet of the gas-liquid separator, the exterior heat exchanger is connected to the first expansion means group, and the evaporator is connected to the second expansion means group.

Here, one of the heat exchange medium passing through the interior heat exchanger and the heat exchange medium passing through the exterior heat exchanger may be supplied to the gas-liquid separator by the first expansion means group and the second expansion means group.

Preferably, the first expansion means group may include a 3-way valve type first expansion means including two inlets and one outlet, a 2-way valve type second expansion means, and a third flow path connecting the first line at the outlet side of the interior heat exchanger to the first expansion means and the second expansion means through a second branch part, an outlet of the first expansion means may be connected to the second line at the inlet side of the exterior heat exchanger, one of inlets of the first expansion means may be connected to the second flow path, and an outlet of the second expansion means may be connected to the first flow path.

Preferably, the second expansion means group may include a 3-way valve type third expansion means including two inlets and one outlet, a 2-way valve type fourth expansion means, and a fourth flow path connecting the second line at the outlet side of the exterior heat exchanger to the third expansion means and the fourth expansion means through a third branch part, an outlet of the third expansion means may be connected to the first line at the inlet side of the evaporator, one of inlets of the third expansion means may be connected to the second flow path, and an outlet of the fourth expansion means may be connected to the first flow path.

Preferably, the vehicle heat management device may include a chiller and a fifth expansion means that are disposed on the fourth line, and a heat exchange medium moving along the fourth line and a heat exchange medium moving along a fifth line may exchange heat in the chiller.

Preferably, the fifth expansion means may be disposed at an inlet side of the chiller.

Preferably, a battery, a pump, and a heater may be disposed on the fifth line.

Preferably, the heat exchange medium moving along the fourth line may be refrigerant, and the heat exchange medium moving along the fifth line may be cooling water.

Meanwhile, the third line may be provided as only a pipe without a check valve.

In a cooling mode of the vehicle heat management device, a heat exchange medium passing through the interior heat exchanger may flow into the gas-liquid separator through the first expansion means, the exterior heat exchanger, and the fourth expansion means, gaseous heat exchange medium separated in the gas-liquid separator may move to the compressor through the third line, and liquid heat exchange medium separated in the gas-liquid separator may move to the evaporator through the third expansion means.

In a heating mode of the vehicle heat management device, a heat exchange medium passing through the interior heat exchanger may flow into the gas-liquid separator through the second expansion means, gaseous heat exchange medium separated in the gas-liquid separator may move to the compressor through the third line, and liquid heat exchange medium separated in the gas-liquid separator may move to the exterior heat exchanger, the fifth expansion means, the chiller, an accumulator, and the compressor through the first expansion means.

In a dehumidification mode of the vehicle heat management device, a heat exchange medium passing through the interior heat exchanger may flow into the gas-liquid separator through the second expansion means, gaseous heat exchange medium separated in the gas-liquid separator may move to the compressor through the third line, some of liquid heat exchange medium separated in the gas-liquid separator may move to the exterior heat exchanger, the fifth expansion means, the chiller, the accumulator, and the compressor through the first expansion means, and the others of the liquid heat exchange medium separated in the gas-liquid separator may move to the evaporator through the third expansion means.

To achieve the objects, a vapor injection module includes a 3-way valve type first expansion means, a 2-way valve type second expansion means, a 3-way valve type third expansion means, a 2-way valve type fourth expansion means, one gas-liquid separator, and a first branch part connecting a liquid outlet of the gas-liquid separator to the first expansion means and the third expansion means, wherein the first branch part is disposed under the gas-liquid separator.

Preferably, the first expansion means and the second expansion means may be disposed to overlap each other in a first direction, and the third expansion means and the fourth expansion means may be disposed to overlap each other in the first direction.

Preferably, the first expansion means and the third expansion means may be disposed to overlap each other in a second direction, and the second expansion means and the fourth expansion means may be disposed to overlap each other in the second direction.

Preferably, the second expansion means and the fourth expansion means may be disposed to overlap the gas-liquid separator in a third direction.

Preferably, the first expansion means and the third expansion means may be disposed to overlap the first branch part in the third direction.

### Advantageous Effects

According to the embodiments, by selectively supplying one of a heat exchange medium passing through an interior heat exchanger or a heat exchange medium passing through an exterior heat exchanger to one gas-liquid separator using a plurality of expansion means, it is possible to improve cooling and heating performance and implement the compact vehicle heat management device.

According to the embodiments, by removing the check valve disposed at the gaseous outlet side of the conventional gas-liquid separator, it is possible to improve cooling and heating performance and implement the compact vehicle heat management device.

According to the embodiments, it is possible to improve cooling and heating performance and implement the compact vehicle heat management device through the vapor injection module commonly using only one gas-liquid separator connected to the plurality of expansion means. Therefore, it is possible to increase the degree of freedom in design of the vehicle heat management device.

According to the embodiments, it is possible to efficiently perform management according to maintenance through the vapor injection module modularized for each component.

According to the embodiments, it is possible to increase heat management efficiency using heat (hereinafter referred to as “waste heat”) generated and discarded from a battery in the heating or dehumidification mode.

Various useful advantages and effects of the embodiments are not limited to the above-described contents and will be more easily understood from descriptions of the specific embodiments.

### DESCRIPTION OF DRAWINGS

FIG. 1 is a view showing a vehicle heat management device according to an embodiment.

FIG. 2 is a view showing the arrangement relationship between components of a vapor injection module disposed in the vehicle heat management device according to the embodiment.

FIG. 3 is a view showing a cooling water circulation structure connected to a chiller of the vehicle heat management device according to the embodiment.

FIG. 4 is a perspective view showing the vapor injection module disposed in the vehicle heat management device according to the embodiment.

FIG. 5 is a bottom perspective view showing the vapor injection module disposed in the vehicle heat management device according to the embodiment.

FIG. 6 is a perspective view showing a first expansion means group and a second expansion means group of the vapor injection module disposed in the vehicle heat management device according to the embodiment.

FIG. 7 is a view showing a cooling mode of the vehicle heat management device according to the embodiment.

FIG. 8 is a view showing a heating mode of the vehicle heat management device according to the embodiment.

FIG. 9 is a view showing a dehumidification mode of the vehicle heat management device according to the embodiment.

### MODE FOR INVENTION

Since the present invention allows various changes and has many embodiments, specific embodiments will be illustrated in the accompanying drawings and described. However, this is not intended to limit the present invention to the specific embodiments, and it is to be appreciated that all changes, equivalents, and substitutes that fall within the spirit and technical scope of the present invention are encompassed in the present invention.

Although the terms “first,” “second,” and the like may be used herein to describe various elements, these elements should not be limited by these terms. These terms are only used to distinguish one element from another element. For example, a second element could be termed a first element, and a first element could similarly be termed a second element without departing from the scope of the present invention. The term “and/or” includes any one or any combination among a plurality of associated listed items.

When an element is referred to as being “connected” or “coupled” to another element, it will be understood that the element can be directly connected or coupled to another element, or other elements may be present therebetween. In contrast, when an element is referred to as being “directly connected” or “directly coupled” to another element, it will be understood that there are no intervening elements.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The terminology used herein is for the purpose of describing particular embodiments only and is not intended to limit the present invention. The singular forms are intended to include the plural forms, unless the context clearly indicates otherwise. In the present specification, it should be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless otherwise defined, all terms including technical and scientific terms used herein have meanings which are the same as meanings generally understood by those skilled in the art. Terms, such as those defined in commonly used dictionaries, should be interpreted as having meanings that are consistent with their meanings in the context of the relevant art and will not be interpreted in an idealized or overly formal sense unless expressly so defined here.

Hereinafter, when embodiments are described in detail with reference to the accompanying drawings, components that are the same or correspond to each other will be denoted by the same or corresponding reference numerals in all drawings, and redundant descriptions will be omitted.

A vehicle may be provided with an air conditioner for controlling air temperature, humidity, cleanliness, ventilation, etc. and may create a comfortable environment in a vehicle interior using the air conditioner. Here, the air conditioner may be referred to as heating/ventilation/air conditioning (HVAC).

In addition, when the vehicle uses a fuel cell, etc. as a driving source, the vehicle may include a separate battery cooling water circulation structure that may cool a battery. Here, the vehicle may be an electric vehicle, a fuel cell vehicle, etc.

Therefore, a vehicle heat management device according to an embodiment can increase heat management efficiency by implementing a heat pump structure that uses heat (hereinafter referred to as “waste heat”) discarded in the battery cooling water circulation structure in the air conditioner.

Here, the vehicle heat management device according to the embodiment uses waste heat of the battery as an example, but is not necessarily limited thereto. For example, the vehicle may be provided with electrical components such as a motor, an inverter, a light and detection ranging (LiDAR), a radar, and a sensor, and the vehicle heat management device according to the embodiment may use waste heat of the electrical components.

That is, the vehicle heat management device according to the embodiment can improve the cooling and heating performance and quality of a vehicle interior using the waste heat according to an air conditioning mode.

Meanwhile, the vehicle heat management device according to the embodiment may remove the check valve disposed at the gaseous outlet side of the gas-liquid separator through a plurality of expansion means and a flow path structure connecting the gas-liquid separator to each of the expansion means while commonly using only one gas-liquid separator. Therefore, the vehicle heat management device may be implemented in a compact size while improving the cooling and heating performance and quality of the vehicle interior. Here, the vehicle heat management device may be referred to as a vapor injection heat pump system. In addition, the flow path structure may be a passage through which the heat exchange medium moves.

In particular, the embodiment may provide a compact vehicle heat management device while improving cooling and heating performance by controlling a vapor injection module including a plurality of expansion means and one gas-liquid separator and a heat exchange medium moving on the vapor injection module. Here, the expansion means may be an expansion valve.

That is, the vehicle heat management device may easily perform maintenance while increasing a degree of freedom in design through a modularized vapor injection module.

Furthermore, the vehicle heat management device according to the embodiment can optimize a flow of the heat exchange medium by presenting an optimized arrangement relationship between components of the vapor injection module. Therefore, the vehicle heat management device can further improve cooling and heating performance.

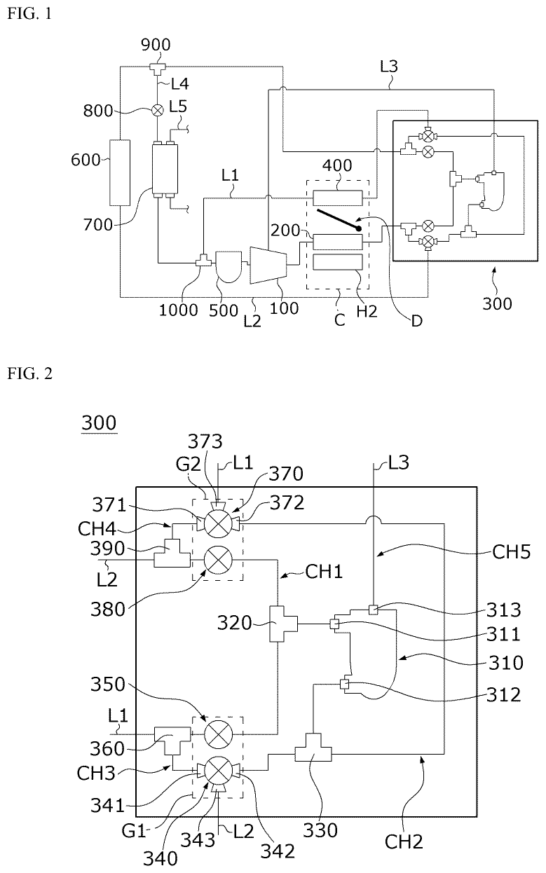

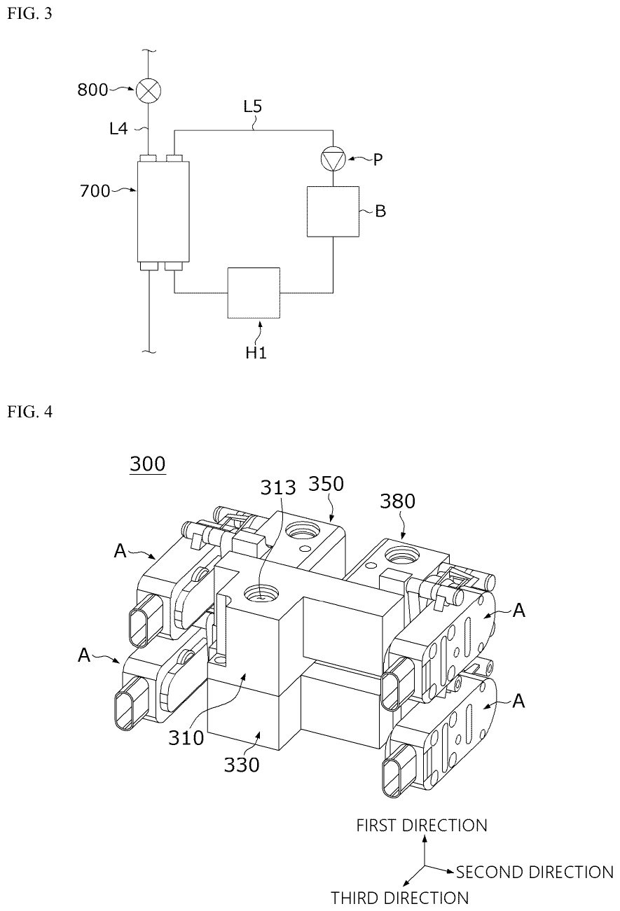

FIG. 1 is a view showing a vehicle heat management device according to an embodiment, FIG. 2 is a view showing the arrangement relationship between components of a vapor injection module disposed in the vehicle heat management device according to the embodiment, and FIG. 3 is a view showing a cooling water circulation structure connected to a chiller of the vehicle heat management device according to the embodiment.

Referring to FIGS. 1 to 3, the vehicle heat management device according to the embodiment may include a first line L1 that connects a compressor 100, an interior heat exchanger 200, a vapor injection module 300, an evaporator 400, and an accumulator 500 so that a heat exchange medium moves, a second line L2 that connects the vapor injection module 300 to an exterior heat exchanger 600, a third line L3 that connects the vapor injection module 300 to the compressor 100, and a fourth line L4 having one side connected to the first line L1 between the evaporator 400 and the accumulator 500 and the other side connected to the second line L2 between the exterior heat exchanger 600 and the vapor injection module 300. Here, the heat exchange medium moving along the first line L1, the second line L2, the third line L3, and the fourth line L4 may be refrigerant and may be referred to as a first heat exchange medium.

In addition, the vapor injection module 300 may include a first expansion means group G1 connected to the first line L1 at an outlet side of the interior heat exchanger 200 based on the flow of the heat exchange medium, a second expansion means group G2 connected to the second line L2 at an outlet side of the exterior heat exchanger 600 based on the flow of the heat exchange medium, one gas-liquid separator 310, a first flow path CH1 that connects the first expansion means group G1, the second expansion means group G2, and an inlet 311 of a gas-liquid separator 310 through a first joining part 320, and a second flow path CH2 that connects the gas-liquid separator 310 to the first expansion means group G1 and the second expansion means group G2 through a first branch part 330 disposed at a liquid outlet 312 side of the gas-liquid separator 310. Here, the first flow path CH1 may be referred to as a first internal flow path, and the second flow path CH2 may be referred to as a second internal flow path. In this case, the first expansion means group G1 may be used in a heating mode and thus may be referred to as a first expansion means group for heating, and the second expansion means group G2 may be used in a cooling mode and thus may be referred to as a second expansion means group for cooling.

In addition, the first expansion means group G1 may include a 3-way valve type first expansion means 340 including two inlets and one outlet, a 2-way valve type second expansion means 350, and a third flow path CH3 that connects the first line L1 at the outlet side of the interior heat exchanger to the first expansion means 340 and the second expansion means 350 through a second branch part 360. Here, the third flow path CH3 may be referred to as a third internal flow path. In addition, the first expansion means 340 may be an electronic 3-way expansion valve. In addition, the second expansion means 350 may be an electronic 2-way expansion valve.

In addition, the second expansion means group G2 may include a 3-way valve type third expansion means 370 including two inlets and one outlet, a 2-way valve type fourth expansion means 380, and a fourth flow path CH4 that connects the second line L2 at the outlet side of the exterior heat exchanger 600 to the third expansion means 370 and the fourth expansion means 380 through a third branch part 390. Here, the fourth flow path CH4 may be referred to as a fourth internal flow path. In addition, the third expansion means 370 may be an electronic 3-way expansion valve. In addition, the fourth expansion means 380 may be an electronic 2-way expansion valve.

Therefore, the vehicle heat management device may commonly use one gas-liquid separator 310 by arranging two 2-way expansion valves in parallel at a front end of the inlet 311 and arranging two 3-way expansion valves in parallel at a rear end of the liquid outlet 312 with respect to the gas-liquid separator 310.

In addition, the vehicle heat management device may include a chiller 700 and a fifth expansion means 800 that are disposed on the fourth line L4.

In addition, the vehicle heat management device may include a fifth line L5 connected to the chiller 700 to use waste heat of a battery B, the battery B disposed on the fifth line L5, etc.

In this case, the vehicle heat management device may be implemented as a compact vehicle heat management device while controlling cooling and heating of the vehicle interior by controlling the movement of the heat exchange medium through the modularized vapor injection module 300, and the first line L1, the second line L2, the third line L3, and the fourth line L4 that are connected to the vapor injection module 300.

Specifically, the vehicle heat management device may control the cooling and heating of the vehicle interior by controlling the heat exchange medium moving in the vapor injection module 300 according to the air conditioning mode. In addition, a compact vehicle heat management device may be implemented through optimization and modularization of the arrangement structure of the vapor injection module 300.

The first line L1 may be a pipe disposed so that the first heat exchange medium circulates with respect to the vapor injection module 300.

In addition, the compressor 100, the interior heat exchanger 200, the vapor injection module 300, the evaporator 400, and the accumulator 500 may be disposed on the first line L1 based on the flow of the first heat exchange medium.

The compressor 100 compresses the first heat exchange medium moving along the first line L1 and then discharges the first heat exchange medium in a high-temperature, high-pressure gaseous state toward the interior heat exchanger 200. Therefore, the first heat exchange medium may circulate inside the vehicle heat exchange device. Here, the compressor 110 may be referred to as a compressor.

The interior heat exchanger 200 may be disposed inside an air conditioning case C of an air conditioner and may enable heat exchange between air, which is a heat exchange medium different from the first heat exchange medium, and the first heat exchange medium compressed by the compressor 100 and flowing therein. Therefore, the interior heat exchanger 120 heats the vehicle interior. Here, the interior heat exchanger 200 may be referred to as a first heat exchanger or a first condenser and may function as a condenser according to the air conditioning mode. In addition, the air exchanging heat with the first heat exchange medium in the interior heat exchanger 200 may be air flowing into the vehicle interior.

In describing the interior heat exchanger 200, the heat exchange between the air and the first heat exchange medium is described as an example, but the present invention is not necessarily limited thereto. For example, the vehicle interior may be heated by arranging a separate cooling water line and exchanging heat between the cooling water moving along the cooling water line and the first heat exchange medium. Specifically the vehicle interior may be heated through heat exchange between the cooling water and the refrigerant, which is the first heat exchange medium, using a water condenser type heat exchanger.

The vapor injection module 300 may control a direction of the movement of the first heat exchange medium according to whether the first heat exchange medium expands, distinction between the gaseous first heat exchange medium and the liquid first heat exchange medium, and the air conditioning mode.

Preferably, the vapor injection module 300 may include the first expansion means group G1 and the second expansion means group G2 that are composed of the 3-way valve type expansion means and the 2-way valve type expansion means, one gas-liquid separator 310, and the plurality of internal flow paths. Therefore, the vapor injection module 300 controls the expansion and movement of the first heat exchange medium flowing therein and supplies one of the gaseous and liquid first heat exchange medium separated in the gas-liquid separator 310 to at least any one of the first line L1, the second line L2, and the third line L3. Here, the first expansion means group G1 may include the first expansion means 340 and the second expansion means 350, and the second expansion means group G2 may include the third expansion means 370 and the fourth expansion means 380.

The gas-liquid separator 310 may separate the first heat exchange medium flowing therein into a gas phase and a liquid phase and discharge the first heat exchange medium for each phase.

Referring to FIG. 2, the gas-liquid separator 310 may include the inlet 311 through which the first heat exchange medium is introduced, the liquid outlet 312 through which the liquid first heat exchange medium is discharged, and the gaseous outlet 313 through which the gaseous first heat exchange medium is discharged.

The inlet 311 of the gas-liquid separator 310 may be connected to the first expansion means group G1 and the second expansion means group G2 through the first flow path CH1.

Specifically, the inlet 311 of the gas-liquid separator 310 may be connected to the second expansion means 350 and the fourth expansion means 380 through the first joining part 320 of the first flow path CH1. In addition, through control of the second expansion means 350 and the fourth expansion means 380 according to the air conditioning mode, one of the first heat exchange medium passing through the interior heat exchanger 200 and the first heat exchange medium passing through the exterior heat exchanger 600 may flow into the gas-liquid separator 310. In addition, the first heat exchange medium flowing into the gas-liquid separator 310 may be separated into a gas phase and a liquid phase by the gas-liquid separator 310.

In this case, since the 2-way valve type second expansion means 350 and fourth expansion means 380 are disposed at an upstream side of the gas-liquid separator 310 based on the flow of the first heat exchange medium and the first heat exchange medium passing through any one of the second expansion means 350 and the fourth expansion means 380 is selectively supplied to the gas-liquid separator 310, the vehicle heat exchange device may remove the check valve disposed on the third line L3 connected to the gaseous outlet 313 and constitute the third line L3 using only a pipe. Therefore, the vehicle heat exchange device can increase heat efficiency by preventing pressure loss due to the check valve, etc. In addition, the vehicle heat exchange device can increase a degree of freedom in design using a space of the check valve.

The liquid outlet 312 of the gas-liquid separator 310 may connect the first expansion means 340 of the first expansion means group G1 to the third expansion means 370 of the second expansion means group G2 through the second flow path CH2. In this case, the liquid outlet 312 may be disposed on a lower portion of the gas-liquid separator 310, thereby increasing the efficiency of discharging liquid refrigerant.

Specifically, the liquid outlet 312 of the gas-liquid separator 310 may be connected to the first expansion means 340 and the third expansion means 370 through the first branch part 330 of the second flow path CH2. Here, one side of the first expansion means 340 may be connected to the second line L2, and one side of the third expansion means 370 may be connected to the first line L1.

In addition, through control of the first expansion means 340 and the third expansion means 370 according to the air conditioning mode, the liquid first heat exchange medium may move to the evaporator 400, the exterior heat exchanger 600, or both the evaporator 400 and the exterior heat exchanger 600.

The gaseous outlet 312 of the gas-liquid separator 310 may be connected to the third flow path CH3. In this case, the vapor injection module 300 may include a fifth flow path CH5 to connect the gaseous outlet 312 to the third flow path CH3. Here, the fifth flow path CH5 may be referred to as a fifth internal flow path.

Therefore, the gaseous first heat exchange medium discharged through the gaseous outlet 312 may be supplied to the compressor 100.

The first joining part 320 may be disposed on the first flow path CH1 disposed to be connected to the inlet 311 side of the gas-liquid separator 310.

Here, the first joining part 320 may be a joining point at which the first heat exchange medium passing through the interior heat exchanger 200 and the first heat exchange medium passing through the exterior heat exchanger 600 join.

The first branch part 330 may be disposed on the second flow path CH2 disposed to be connected to the gaseous outlet 312 side of the gas-liquid separator 310.

Here, the first branch part 330 may be a branch point at which the liquid first heat exchange medium is branched to move.

The first expansion means 340 together with the second expansion means 350 may constitute the first expansion means group G1 and may be provided as a 3-way valve type valve. Therefore, the first expansion means 340 may control the moving direction and presence or absence of expansion of the first heat exchange medium.

In addition, the first expansion means 340 may include two inlets and one outlet.

A first inlet 341 that is one of the two inlets of the first expansion means 340 may be connected to the first line L1 disposed at an outlet side of the interior heat exchanger 200 through the second branch part 360 disposed on the third flow path CH3.

In addition, a second inlet 342 that is the other of the two inlets of the first expansion means 340 may be connected to a portion of the second flow path CH1 branched from the second branch part 360.

In addition, a first outlet 343 that is the outlet of the first expansion means 340 may be connected to the second line L2 at an inlet side of the exterior heat exchanger 600.

Therefore, according to the air conditioning mode, the first heat exchange medium introduced through the first inlet 341 may be discharged to the first outlet 343 by the first expansion means 340 and supplied to the exterior heat exchanger 600. In addition, according to the air conditioning mode, the first heat exchange medium introduced through the second inlet 342 may be discharged to the first outlet 343 by the first expansion means 340 and supplied to the exterior heat exchanger 600.

The second expansion means 350 together with the first expansion means 340 may constitute the first expansion means group G1 and may be provided as a 2-way valve type valve. Therefore, the second expansion means 350 may control the movement and presence or absence of expansion of the first heat exchange medium.

An inlet of the second expansion means 350 may be connected to the first line L1 disposed at the outlet side of the interior heat exchanger 200 through the second branch part 360 disposed on the third flow path CH3.

In addition, an outlet of the second expansion means 340 may be connected to the inlet 311 of the gas-liquid separator 310 through the first joining part 320 disposed on the first flow path CH1.

According to the air conditioning mode, the second expansion means 350 may control the movement and expansion of the first heat exchange medium supplied to the gas-liquid separator 310.

The second branch part 360 may be disposed on the third flow path CH3 disposed to be connected to the first line L1 at the outlet side of the interior heat exchanger 200.

Here, the second branch part 360 may be a branch point at which the first heat exchange medium discharged from the interior heat exchanger 200 is branched to move.

The third expansion means 370 together with the fourth expansion means 380 may constitute the second expansion means group G2 and may be provided as a 3-way valve type valve. Therefore, the third expansion means 370 may control the moving direction and presence or absence of expansion of the first heat exchange medium.

In addition, the third expansion means 370 may include two inlets and one outlet.

A third inlet 371 that is one of the two inlets of the third expansion means 370 may be connected to the second line L2 disposed at the outlet side of the exterior heat exchanger 600 through the third branch part 390 disposed on the third flow path CH3.

In addition, a fourth inlet 372 that is the other of the two inlets of the third expansion means 370 may be connected to a portion of the second flow path CH1 branched from the second branch part 360.

In addition, a second outlet 373 that is an outlet of the third expansion means 370 may be connected to the first line L1 at an inlet side of the evaporator 400.

Therefore, according to the air conditioning mode, the first heat exchange medium introduced through the third inlet 371 may be discharged to the second outlet 373 by the third expansion means 370 and supplied to the evaporator 400. In addition, according to the air conditioning mode, the first heat exchange medium introduced through the fourth inlet 372 may be discharged to the second outlet 373 by the third expansion means 370 and supplied to the evaporator 400.

The fourth expansion means 380 together with the third expansion means 370 may constitute the second expansion means group G2 and may be provided as a 2-way valve type valve. Therefore, the fourth expansion means 380 may control the movement and presence or absence of expansion of the first heat exchange medium.

An inlet of the fourth expansion means 380 may be connected to the second line L2 disposed at the outlet side of the exterior heat exchanger 600 through the third branch part 390 disposed on the fourth flow path CH3.

In addition, an outlet of the fourth expansion means 380 may be connected to the inlet 311 of the gas-liquid separator 310 through the first joining part 320 disposed on the first flow path CH1.

According to the air conditioning mode, the second expansion means 350 may control the movement and expansion of the first heat exchange medium supplied to the gas-liquid separator 310.

The third branch part 390 may be disposed on the fourth flow path CH4 disposed to be connected to the second line L2 at the outlet side of the exterior heat exchanger 600.

Here, the third branch part 390 may be a branch point at which the first heat exchange medium discharged from the exterior heat exchanger 600 is branched to move.

The first flow path CH1, the second flow path CH2, the third flow path CH3, the fourth flow path CH4, and the fifth flow path CH5 may be passages which is disposed in the vapor injection module 300 and through which the first heat exchange medium moves.

The first flow path CH1 may connect the inlet 311 of the gas-liquid separator 310, the outlet of the second expansion means 350, and the outlet of the fourth expansion means 380 using the first joining part 320. In this case, one of the first heat exchange medium passing through the second expansion means 350 or the first heat exchange medium passing through the fourth expansion means 380 may be supplied to the gas-liquid separator 310 by control of the second expansion means 350 and the fourth expansion means 380.

The second flow path CH2 may connect the liquid outlet 312 of the gas-liquid separator 310, the second inlet 342 of the first expansion means 340, and the fourth inlet 372 of the third expansion means 370 using the first branch part 330. In this case, the liquid first heat exchange medium discharged from the gas-liquid separator 310 may be supplied to the exterior heat exchanger 600 through the first expansion means 340, supplied to the evaporator 400 through the third expansion means 370, or supplied to both the evaporator 400 and the exterior heat exchanger 600 by control of the first expansion means 340 and the third expansion means 370.

The third flow path CH3 may connect the outlet of the interior heat exchanger 200, the first inlet 341 of the first expansion means 340, and the inlet of the second expansion means 350 using the second branch part 360. In this case, the first heat exchange medium discharged from the interior heat exchanger 200 may be supplied to the exterior heat exchanger 600 through the first expansion means 340 or supplied to the gas-liquid separator 310 through the second expansion means 350 by control of the first expansion means 340 and the second expansion means 350.

The fourth flow path CH4 may connect the outlet of the exterior heat exchanger 600, the third inlet 371 of the third expansion means 370, and the inlet of the fourth expansion means 380 using the third branch part 390. In this case, the first heat exchange medium discharged from the exterior heat exchanger 200 may be supplied to the gas-liquid separator 310 through the fourth expansion means 380 by control of the third expansion means 370 and the fourth expansion means 380.

The fifth flow path CH5 may connect the gaseous outlet 313 of the gas-liquid separator 310 to the third line L3 connected to an inlet side of the compressor 100. Therefore, the gaseous first heat exchange medium discharged from the gaseous outlet 313 of the gas-liquid separator 310 may be supplied to the compressor 100.

The vapor injection module 300 can optimize the flow of the heat exchange medium by presenting an arrangement relationship between optimized components of the first expansion means group G1 including the first expansion means 340 and the second expansion means 350, the second expansion means group G2 including the third expansion means 370 and the fourth expansion means 380, the gas-liquid separator 310, and the first branch part 330. In addition, the vapor injection module 300 can increase the degree of freedom in design of the vehicle heat management device by implementing a compact vapor injection module through the above arrangement relationship. Furthermore, components of each of the first expansion means group G1, the second expansion means group G2, the gas-liquid separator 310, and the first branch part 330 may be modularized to facilitate assembly, maintenance, etc.

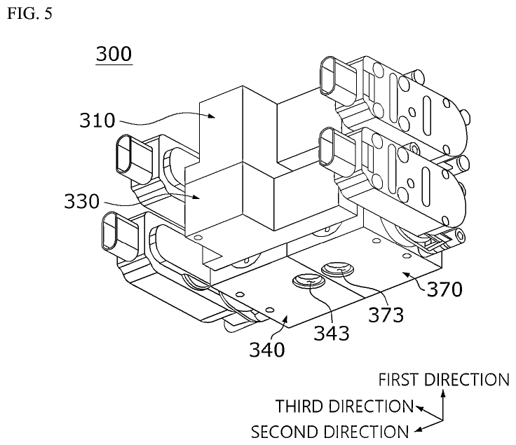

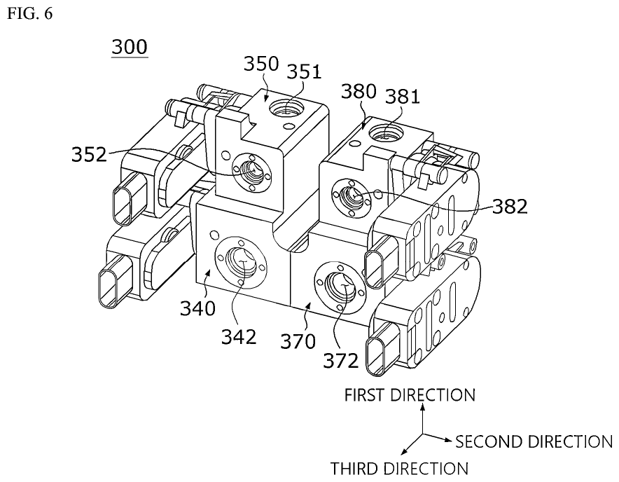

FIG. 4 is a perspective view showing the vapor injection module disposed in the vehicle heat management device according to the embodiment, FIG. 5 is a bottom perspective view showing the vapor injection module disposed in the vehicle heat management device according to the embodiment, and FIG. 6 is a perspective view showing a first expansion means group and a second expansion means group of the vapor injection module disposed in the vehicle heat management device according to the embodiment. First, second, and third directions shown in FIGS. 4 to 6 are different directions and may be perpendicular. In addition, the first direction may represent a vertical direction or a perpendicular direction. In this case, the top of the drawing may represent upward and the bottom thereof may represent downward in consideration of a location of the gaseous outlet 313 of the gas-liquid separator 310. In addition, the second and third directions may be horizontal directions in a plan view and may be perpendicular.

Referring to FIGS. 4 to 6, the vapor injection module 300 may include the first expansion means group G1 including the first expansion means 340 and the second expansion means 350, the second expansion means group G2 including the third expansion means 370 and the fourth expansion means 380, the gas-liquid separator 310, and the first branch part 330. In this case, the first joining part 320 may be disposed in a unit forming the gas-liquid separator 310, that is, a gas-liquid separator housing. In addition, the second branch part 360 may be disposed in a unit forming the second expansion means 350, that is, a second expansion means housing. In addition, the third branch part 390 may be disposed in a unit forming the fourth expansion means 380, that is, a fourth expansion means housing.

In addition, the vapor injection module 300 may include an actuator A disposed to correspond to each of the first expansion means 340, the second expansion means 350, the third expansion means 370, and the fourth expansion means 380. Therefore, each of the first expansion means 340, the second expansion means 350, the third expansion means 370, and the fourth expansion means 380 may be individually driven by the actuator A.

Here, although an example in which the first expansion means 340, the second expansion means 350, the third expansion means 370, the fourth expansion means 380, the gas-liquid separator 310, and the first branch part 330 are formed as a hexahedral-shaped unit is described, the present invention is not necessarily limited thereto. When the arrangement relationship of each of the first expansion means 340, the second expansion means 350, the third expansion means 370, the fourth expansion means 380, the gas-liquid separator 310, and the first branch part 330 is satisfied, the above components may be formed in various shapes.

Meanwhile, since the vapor injection module 300 constitutes the first branch part 330 that is connected to the liquid outlet 312 of the gas-liquid separator 310 as a separate unit and is disposed under the gas-liquid separator 310, it is possible to optimize the flow of the liquid first heat exchange medium by its weight. In this case, the gaseous outlet 133 of the gas-liquid separator 310 may be disposed upward considering that it is an outlet through which the gaseous first heat exchange medium is discharged.

Referring to FIG. 6, the first expansion means 340 and the second expansion means 350 may be disposed to overlap each other in a vertical direction that is a first direction. In this case, it is preferable that the inlet 311 of the gas-liquid separator 310 is disposed higher than the liquid outlet 312 in consideration of the weight of the first heat exchange medium for each phase inside the gas-liquid separator 310. Therefore, the second expansion means 350 connected to the inlet 311 of the gas-liquid separator 310 may be disposed above the first expansion means 240.

In addition, the third expansion means 370 and the fourth expansion means 380 may be disposed to overlap each other in the vertical direction that is the first direction. In this case, it is preferable that the inlet 311 of the gas-liquid separator 310 is disposed higher than the liquid outlet 312 in consideration of the weight of the first heat exchange medium for each phase inside the gas-liquid separator 310. Therefore, the fourth expansion means 380 connected to the inlet 311 of the gas-liquid separator 310 may be disposed above the third expansion means 370.

In this case, the optimized arrangement relationship can be provided by arranging the first expansion means 340 and the third expansion means 370 to overlap each other in a second direction and arranging the second expansion means 350 and the fourth expansion means 380 to overlap each other in the second direction.

In addition, the second expansion means 350 and the fourth expansion means 380 may be disposed to overlap the gas-liquid separator 310 in a third direction in a plan view. In this case, the inlet 351 of the second expansion means 350 may be disposed upward, and the outlet 352 may be disposed toward the gas-liquid separator 310. In addition, the inlet 381 of the fourth expansion means 380 may be disposed upward, and the outlet 382 may be disposed toward the gas-liquid separator 310. Here, the inlet 351 of the second expansion means 350 may be connected to the outlet side of the interior heat exchanger 200. In addition, the inlet 381 of the fourth expansion means 380 may be connected to the outlet side of the exterior heat exchanger 600.

In addition, the first expansion means 340 and the third expansion means 370 may be disposed to overlap the first branch part 330 in the third direction in a plan view. In this case, the second inlet 342 of the first expansion means 340 may be disposed toward the first branch part 330. In addition, the fourth inlet 372 of the third expansion means 370 may be disposed toward the first branch part 330.

As described above, the vapor injection module 300 may constitute the optimized module by presenting the arrangement relationship of the first expansion means 340, the second expansion means 350, the third expansion means 370, and the fourth expansion means 380 based on the arrangement relationship of the gas-liquid separator 310 and the first branch part 330.

The evaporator 400 is installed inside the air conditioning case C of the air conditioner and disposed on the first line L1 to supply a low-temperature, low-pressure first heat exchange medium discharged from the third expansion means 370. In this case, the air flowing inside the air conditioning case C through a blower is changed into cold air by exchanging heat with the first heat exchange medium inside the evaporator 400 in a process of passing through the evaporator 400 and is then discharged to the vehicle interior to cool the vehicle interior. That is, the evaporator 400 may cool the vehicle interior by inducing heat exchange between the air discharged to the vehicle interior and the first heat exchange medium. Here, the evaporator may be referred to as a third heat exchanger.

In this case, the interior heat exchanger 200 and the evaporator 400 may be disposed together inside the air conditioning case C to control cooling and heating of the interior. In addition, a temperature control door D disposed inside the air conditioning case C may control a temperature of the vehicle interior by controlling the amount of air heat-exchanged through the interior heat exchanger 200 and the evaporator 400.

The accumulator 500 may be installed on the first line L1 at the inlet side of the compressor 110. In addition, the accumulator 500 may selectively discharge the liquid (liquid state) first heat exchange medium or the gaseous (gaseous state) first heat exchange medium from the first heat exchange medium flowing therein.

In this case, a second joining part 1000 at which the first heat exchange medium moving along the first line L1 and the fourth line L4 join may be disposed at an inlet side of the accumulator 500. Therefore, the first heat exchange medium passing through the evaporator 400 may be supplied to the accumulator 500 by the third expansion means 370, or the first heat exchange medium passing through the chiller 700 may be supplied to the accumulator 500 by the fifth expansion means 800, or the first heat exchange medium passing through the evaporator 400 and the first heat exchange medium passing through the chiller 700 may be joined and supplied to the accumulator 500.

The exterior heat exchanger 600 may be installed at a front side of a vehicle to condense the first heat exchange medium by exchanging heat between air (air outside a vehicle interior) flowing into the vehicle and the first heat exchange medium and dissipating the heat. Here, the exterior heat exchanger 600 may be referred to as a second heat exchanger or a second condenser.

In this case, the exterior heat exchanger 600 may be disposed on the second line L2. In addition, the first heat exchange medium passing through the first expansion means 340 may be supplied.

The chiller 700 and the fifth expansion means 800 for using waste heat may be disposed on the fourth line L4. Here, the fifth expansion means 800 may be provided as a 2-way valve type. For example, the fifth expansion means 800 may be a 2-way expansion valve.

The fourth line L4 may connect the first line L1 between the evaporator 400 and the accumulator 500 and the second line L2 between the exterior heat exchanger 600 and the vapor injection module 300 using a fourth branch part 900 and a second joining part 1000. Therefore, some of the first heat exchange medium passing through the exterior heat exchanger 600 may move to the fourth line L4. In addition, the first heat exchange medium passing through the chiller 700 and the fifth expansion means 800 may move to the accumulator 500.

The chiller 700 may be a heat exchanger that enables heat exchange between the first heat exchange medium passing through the fifth expansion means 800 and a second heat exchange medium moving along the fifth line L5. Here, the chiller 700 may be referred to as a fourth heat exchanger. In addition, the second heat exchange medium may be cooling water.

Since the first heat exchange medium exchanges heat with the second heat exchange medium in the chiller 700, the vehicle heat management device may use the waste heat of the battery B as a heat source.

The fifth expansion means 800 may be disposed at an inlet side of the chiller 700. In addition, the fifth expansion means 800 may control the presence or absence of the expansion and movement of the first heat exchange medium moving along the fourth line L4. Here, the fifth expansion means 800 may be an electronic 2-way expansion valve.

The vehicle heat exchanger may include a battery cooling device disposed to use the waste heat of the battery B.

Referring to FIGS. 1 and 3, the battery cooling device may include the fifth line L5 through which the second heat exchange medium circulates, and the battery B and a pump P that are disposed on the fifth line L5. In addition, the battery cooling device may further include a first heater H1.

The fifth line L5 may be disposed in the vehicle so that the second heat exchange medium may circulate. Therefore, the second heat exchange medium circulating through the fifth line L5 may cool the heat generated from the battery B. Here, the fifth line L5 may be provided as a pipe, etc.

In addition, the fifth line L5 may be disposed to pass through the chiller 700. Therefore, the second heat exchange medium transferred along the fifth line L5 may exchange heat with the first heat exchange medium flowing along the fourth line L4 in the chiller 700. That is, the heat generated from the battery B may be transferred from the chiller 700 to the accumulator 500.

The pump P allows the second heat exchange medium to transfer along the fifth line L5. Therefore, the high-temperature second heat exchange medium absorbing the heat generated from the battery B may be circulated by the pump P to exchange heat with the first heat exchange medium while passing through the chiller 700.

The first heater H1 may heat the second heat exchange medium transferred along the fifth line L5. As shown in FIG. 3, the first heater H1 may be disposed at an outlet side of the battery B based on the flow of the second heat exchange medium, but is not necessarily limited thereto. Here, the first heater H1 may be referred to as a first heater.

Meanwhile, the vehicle heat management device may further include a second heater H2 disposed inside the air conditioning case C. Here, the second heater H2 may use a positive temperature coefficient (PTC) heater. Therefore, the PTC heater can assist in cooling and heating the vehicle interior, thereby improving the quality of cooling and heating of the vehicle interior.

The vehicle heat management device according to the embodiment may include a plurality of air conditioning modes.

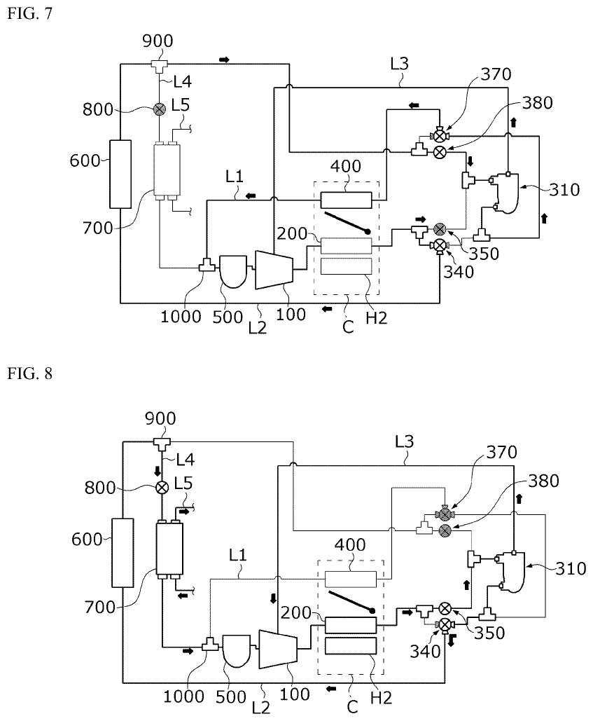

FIG. 7 is a view showing a cooling mode of the vehicle heat management device according to the embodiment. Here, arrows shown in FIG. 7 may indicate the flow of the heat exchange medium.

When the vehicle heat management device is in a cooling mode, the vehicle heat management device may cool the vehicle interior.

Referring to FIGS. 1, 2, and 7, in the cooling mode, the first heat exchange medium passing through the interior heat exchanger 200 may flow into the gas-liquid separator 310 through the first expansion means 340, the exterior heat exchanger 600, and the fourth expansion means 380, the gaseous first heat exchange medium separated in the gas-liquid separator 310 may move to the compressor 100 through the third line L3, and the liquid first heat exchange medium separated in the gas-liquid separator 310 may move to the evaporator 400 through the third expansion means 370.

Specifically, the first heat exchange medium passing through the compressor 100 and the interior heat exchanger 200 may be moved to the exterior heat exchanger 600 by the first expansion means 340 and the second expansion means 350. In this case, the second inlet 342 of the first expansion means 340 and the second expansion means 350 are in a closed state.

In addition, the first heat exchange medium passing through the exterior heat exchanger 600 may be moved to the gas-liquid separator 310 by the third expansion means 370, the fourth expansion means 380, and the fifth expansion means 800. In this case, the third inlet 371 of the third expansion means 370 and the fifth expansion means 800 are in a closed state.

In addition, the first heat exchange medium is separated into a gas phase and a liquid phase inside the gas-liquid separator 310.

In addition, the liquid first heat exchange medium is expanded by the third expansion means 370 and then sequentially moves to the evaporator 400, the accumulator 500, and the compressor 100.

In addition, the gaseous first heat exchange medium moves to the compressor 100 through the third line L3.

That is, in the cooling mode of the vehicle heat management device, in the vehicle heat management device, refrigerant passing through the interior heat exchanger 200 that is the first heat exchanger may flow into the gas-liquid separator 310 through the first expansion means 340, the exterior heat exchanger 600 that is the second heat exchanger, and the fourth expansion means 350, gaseous refrigerant separated in the gas-liquid separator 310 may move to the compressor 100, and liquid refrigerant separated in the gas-liquid separator 310 may be expanded by the third expansion means 350 and then may move to the evaporator 400 that is the third heat exchanger. Here, the refrigerant passing through the interior heat exchanger 200 that is the first heat exchanger is not expanded by the first expansion means 340 and may be expanded by only the fourth expansion means 350 while moving to the first expansion means 340, the exterior heat exchanger 600 that is the second heat exchanger, the fourth expansion means 350, and the gas-liquid separator 310.

Therefore, in the cooling mode of the vehicle heat management device, the vehicle heat management device can improve cooling performance by about 15% and increase cooling efficiency by about 10% compared to conventional heat pump systems using a vapor injection system.

FIG. 8 is a view showing a heating mode of the vehicle heat management device according to the embodiment. Here, arrows shown in FIG. 8 may indicate the flow of the heat exchange medium.

When the vehicle heat management device is in a heating mode, the vehicle heat management device may heat the vehicle interior.

Referring to FIGS. 1, 2, and 8, in the heating mode, the first heat exchange medium passing through the interior heat exchanger 200 may flow into the gas-liquid separator 310 through the second expansion means 350, the gaseous first heat exchange medium separated in the gas-liquid separator 310 may move to the compressor 100 through the third line L3, and the liquid first heat exchange medium separated in the gas-liquid separator 310 may move to the exterior heat exchanger 600, the fifth heat exchanger 800, the chiller 700, the accumulator 500, and the compressor 100 through the first expansion means 340.

Specifically, the first heat exchange medium passing through the compressor 100 and the interior heat exchanger 200 may be moved to the gas-liquid separator 310 by the first expansion means 340, the second expansion means 350, and the fourth expansion means 380. In this case, the first inlet 341 of the first expansion means 340 and the fourth expansion means 380 are in a closed state.

In addition, the first heat exchange medium is separated into a gas phase and a liquid phase inside the gas-liquid separator 310.

In addition, the liquid first heat exchange medium is moved to the exterior heat exchanger 600 by the first expansion means 340 and the third expansion means 370. In this case, the third expansion means 370 is in a closed state. Therefore, the first heat exchange medium passing through the exterior heat exchanger 600 is expanded by the fifth expansion means 800 and then sequentially moves to the chiller 700, the accumulator 500, and the compressor 100. When the first heat exchange medium passes through the chiller 700, the first heat exchange medium may use the waste heat of the battery B by exchanging heat with the second heat exchange medium moving along the fifth line L5 in the chiller 700.

In addition, the gaseous first heat exchange medium moves to the compressor 100 through the third line L3 and then joins the first heat exchange medium moving into the compressor 100 through the accumulator 500.

That is, in the heating mode of the vehicle heat management device, in the vehicle heat management device, refrigerant passing through the interior heat exchanger 200 that is the first heat exchanger may be expanded by the second expansion means 350 and then may flow into the gas-liquid separator 310, gaseous refrigerant separated in the gas-liquid separator 310 may move to the compressor 100, and liquid refrigerant separated in the gas-liquid separator 310 may be expanded by the first expansion means 340, may pass through the exterior heat exchanger 600 that is the second heat exchanger, and then move to the compressor.

Therefore, in the heating mode of the vehicle heat management device, the vehicle heat management device can improve heating performance by about 20% and reduce power consumed in the heating mode by about 10% compared to conventional heat pump systems using a vapor injection system.

Meanwhile, in the heating mode of the vehicle heat management device, the second heater H2 may be driven.

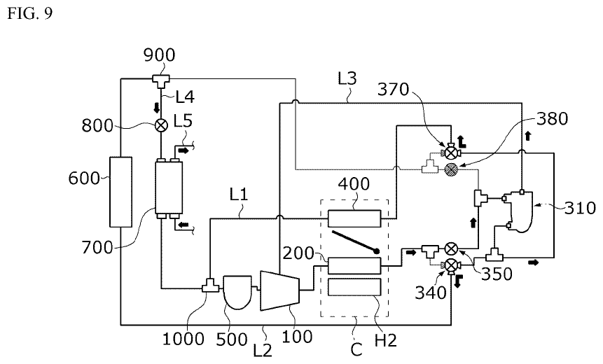

FIG. 9 is a view showing a dehumidification mode of the vehicle heat management device according to the embodiment. Here, arrows shown in FIG. 9 may indicate the flow of the heat exchange medium.

In the dehumidification mode of the vehicle heat management device, the vehicle heat management device may dehumidify the vehicle interior.

Referring to FIGS. 1, 2, and 9, in the dehumidification mode, the first heat exchange medium passing through the interior heat exchanger 200 may flow into the gas-liquid separator 310 through the second expansion means 350, the gaseous first heat exchange medium separated in the gas-liquid separator 310 may move to the compressor 100 through the third line L3, some of the liquid first heat exchange medium separated in the gas-liquid separator 310 may move to the exterior heat exchanger 600, the fifth expansion means 800, the chiller 700, the accumulator 500, and the compressor 100 through the first expansion means 340, and the others of the liquid first heat exchange medium separated in the gas-liquid separator 310 may move to the evaporator 400 through the third expansion means 370.

Specifically, the first heat exchange medium passing through the compressor 100 and the interior heat exchanger 200 may be moved to the gas-liquid separator 310 by the first expansion means 340, the second expansion means 350, and the fourth expansion means 380. In this case, the first inlet 341 of the first expansion means 340 and the fourth expansion means 380 are in a closed state.

In addition, the first heat exchange medium is separated into a gas phase and a liquid phase inside the gas-liquid separator 310.

In addition, some of the liquid first heat exchange medium are moved to the exterior heat exchanger 600, and the others thereof are moved to the evaporator 400 by the first expansion means 340 and the third expansion means 370. In this case, the third inlet 371 of the third expansion means 370 is in a closed state.

Therefore, some of the first heat exchange medium branched from the first branch part 330 pass through the exterior heat exchanger 600, are expanded by the fifth expansion means 800, and then sequentially move to the chiller 700, the accumulator 500, and the compressor 100. When the first heat exchange medium passes through the chiller 700, the first heat exchange medium may use the waste heat of the battery B by exchanging heat with the second heat exchange medium moving along the fifth line L5 in the chiller 700.

In addition, the others of the first heat exchange medium branched from the first branch part 330 are expanded by the third expansion means 370 and then sequentially move to the evaporator 400, the accumulator 500, and the compressor 100.

In addition, the gaseous first heat exchange medium moves to the compressor 100 through the third line L3 and then joins the first heat exchange medium moving into the compressor 100 through the accumulator 500.

Therefore, in the heating mode of the vehicle heat management device, the third expansion means 370 and the fourth expansion means 380 may be controlled to block the first heat exchange medium moving to the evaporator 400. In addition, the vehicle heat management device can improve heating performance by about 20% and reduce power consumed in the heating mode by about 10% compared to conventional heat pump systems using a vapor injection system.

Meanwhile, in the dehumidification mode of the vehicle heat management device, the second heater H2 may be driven.

The embodiment of the present invention has been specifically described above with reference to the accompanying drawings.

The above description is simply given for illustratively describing the technical spirit of the present invention, and those skilled in the art to which the present invention pertains will appreciate that various modifications, changes, and substitutions are possible without departing from the essential characteristic of the present invention. Accordingly, the embodiments disclosed in the present invention and the accompanying drawings are intended not to limit but to describe the technical spirit of the present invention, and the scope of the technical spirit of the present invention is not limited by the embodiments and the accompanying drawings. The protective scope of the present invention should be construed based on the following claims, and all the technical spirit in the equivalent scope thereto should be construed as falling within the scope of the present invention.

### DESCRIPTION OF REFERENCE NUMERALS

100: compressor, 200: interior heat exchanger, 300: vapor injection module, 310: gas-liquid separator, 320: first joining part, 330: first branch part, 340: first expansion means, 350: second expansion means, 360: second branch part, 370: third expansion means, 380: fourth expansion means, 390: third branch part, 400: evaporator, 500: accumulator, 600: exterior heat exchanger, 700: chiller, 800: fifth expansion means, 900: fourth branch part, 1000: second joining part, B: battery, C: air conditioning case.

1. A vehicle heat management device comprising:
a compressor configured to compress and circulate refrigerant;
a first heat exchanger into which the compressed refrigerant is introduced to exchange heat with another heat exchanger medium;
a second heat exchanger configured to exchange heat with air outside a vehicle interior;
a third heat exchanger mounted on an air conditioner to exchange heat with air discharged to the vehicle interior; and
a vapor injection module capable of allowing gaseous refrigerant to flow into the compressor,
wherein the vapor injection module includes a plurality of expansion means and one gas-liquid separator,
in a cooling mode, refrigerant passing through the second heat exchanger flows into the vapor injection module, and
in a heating mode, refrigerant passing through the first heat exchanger flows into the vapor injection module.

2. The vehicle heat management device of claim 1, wherein the vapor injection module includes a first expansion means group for heating and a second expansion means group for cooling,
an outlet of the first heat exchanger is connected to the first expansion means group, and
an outlet of the second heat exchanger is connected to the second expansion means group.

3. The vehicle heat management device of claim 2, wherein the first expansion means group includes a first expansion means, a second expansion means, and a third flow path connecting the outlet of the first heat exchanger to the first expansion means and the second expansion means, and
the second expansion means group includes a third expansion means, a fourth expansion means, and a fourth flow path connecting the outlet of the second heat exchanger to the third expansion means and the fourth expansion means through a third branch part.

4. The vehicle heat management device of claim 3, wherein, in a cooling mode,
the refrigerant passing through the first heat exchanger flows into the gas-liquid separator through the first expansion means, the second expansion means, and the fourth expansion means,
gaseous refrigerant separated in the gas-liquid separator moves to the compressor, and
liquid refrigerant separated in the gas-liquid separator is expanded by the third expansion means and then moves to the third heat exchanger.

5. The vehicle heat management device of claim 4, wherein, when the refrigerant passing through the first heat exchanger moves along the first expansion means, the second heat exchanger, the fourth expansion means, and the gas-liquid separator, the refrigerant is expanded by only the fourth expansion means.

6. The vehicle heat management device of claim 3, wherein, in a heating mode,
the refrigerant passing through the first heat exchanger is expanded by the second expansion means and then flows into the gas-liquid separator,
gaseous refrigerant separated in the gas-liquid separator moves to the compressor, and
liquid refrigerant separated in the gas-liquid separator is expanded by the first expansion means, passes through the second heat exchanger, and then moves to the compressor.

7. The vehicle heat management device of claim 3, wherein, in a dehumidification mode,
the refrigerant passing through the first heat exchanger is expanded by the second expansion means and then flows into the gas-liquid separator,
gaseous refrigerant separated in the gas-liquid separator moves to the compressor,
liquid refrigerant separated in the gas-liquid separator is branched to each of the first expansion means and the third expansion means,
the refrigerant flowing into and expanded by the first expansion means passes through the second heat exchanger and then flows into the compressor, and
the refrigerant flowing into and expanded by the third expansion means passes through the third heat exchanger and then flows into the compressor.

8. A vehicle heat management device comprising:
a compressor configured to compress and circulate refrigerant;
a first heat exchanger into which the compressed refrigerant is introduced to exchange heat with another heat exchanger medium;
a second heat exchanger configured to exchange heat with air outside a vehicle interior;
a third heat exchanger mounted on an air conditioner to exchange heat with air discharged to the vehicle interior; and
a vapor injection module capable of allowing gaseous refrigerant to flow into the compressor,
wherein the vapor injection module includes:
a first expansion means group;
a second expansion means group;
one gas-liquid separator;
a first joining part disposed at an inlet of the gas-liquid separator and connected to the first expansion means group and the second expansion means group; and
a first branch part disposed at a liquid outlet of the gas-liquid separator and connected to the first expansion means group and the second expansion means group.

9. The vehicle heat management device of claim 8, comprising: a first line connecting the compressor, the first heat exchanger, the vapor injection module, the third heat exchanger, and an accumulator;
a second line connecting the vapor injection module to the second heat exchanger;
a third line connecting the vapor injection module to the compressor;
a fourth line having one side connected to the first line between the third heat exchanger and the accumulator and the other side connected to the second line between the second heat exchanger and the vapor injection module; and
a chiller and a fifth expansion means that are disposed on the fourth line.

10. The vehicle heat management device of claim 9, wherein the first expansion means group includes a 3-way valve type first expansion means including two inlets and one outlet, a 2-way valve type second expansion means, and a second branch part disposed at an outlet of the first heat exchanger and connected to the first expansion means and the second expansion means,
the second expansion means group includes a 3-way valve type third expansion means including two inlets and one outlet, a 2-way valve type fourth expansion means, and a third branch part disposed at an outlet of the second heat exchanger and connected to the third expansion means and the fourth expansion means,
an outlet of the first expansion means is connected to the second line at an inlet side of the second heat exchanger,
one of inlets of the first expansion means is connected to the first branch part,
an outlet of the second expansion means is connected to the first joining part,
an outlet of the third expansion means is connected to the first line at an inlet side of the third heat exchanger,
one of inlets of the third expansion means is connected to the first branch part, and
an outlet of the fourth expansion means is connected to the first joining part.

11. The vehicle heat management device of claim 9, wherein refrigerant moving along the fourth line and cooling water moving along a fifth line exchange heat in the chiller.

12. The vehicle heat management device of claim 11, wherein the fifth expansion means is disposed at an inlet side of the chiller, and
a battery, a pump, and a heater are disposed on the fifth line.

13. The vehicle heat management device of claim 9, wherein the third line is provided as only a pipe without a check valve.

14. A vapor injection module comprising: four expansion means; and one gas-liquid separator,
wherein the gas-liquid separator includes an inlet into which refrigerant flows, a liquid outlet through which liquid refrigerant is discharged, and a gaseous outlet through which gaseous refrigerant is discharged, and
the liquid outlet is disposed on a lower portion of the gas-liquid separator.

15. The vapor injection module of claim 14, wherein the four expansion means are composed of a 3-way valve type first expansion means, a 2-way valve type second expansion means, a 3-way valve type third expansion means, and a 2-way valve type fourth expansion means,
the vehicle heat management device includes a first branch part connecting the liquid outlet of the gas-liquid separator, the first expansion means, and the third expansion means, and
the first branch part is disposed under the gas-liquid separator.

16. The vapor injection module of claim 15, wherein the first expansion means and the second expansion means are disposed to overlap each other in a first direction, and
the third expansion means and the fourth expansion means are disposed to overlap each other in the first direction.

17. The vapor injection module of claim 16, wherein the first expansion means and the third expansion means are disposed to overlap each other in a second direction, and
the second expansion means and the fourth expansion means are disposed to overlap each other in the second direction.

18. The vapor injection module of claim 17, wherein the second expansion means and the fourth expansion means are disposed to overlap the gas-liquid separator in a third direction.

19. The vapor injection module of claim 18, wherein the first expansion means and the third expansion means are disposed to overlap the first branch part in the third direction.
